(19) United States
(12) Patent Application Publication
(10) Pub. No.: US 2002/0065072 A1
(43) Pub. Date: May 30, 2002

(54) METHOD AND APPARATUS FOR RESUMING RE-TRANSMISSION AFTER INTERRUPTION

(76) Inventor: ANNIKA LINDH, BROMMA (SE)

Correspondence Address: BURNS DOANE SWECKER & MATHIS L L P, POST OFFICE BOX 1404, ALEXANDRIA, VA, 22313-1404, US

(21) Appl. No.: 09/195,876

(22) Filed: Nov. 19, 1998

(51) Int. Cl. H04Q 7/20

(52) U.S. Cl. 455/422

(57) ABSTRACT

Data is transmitted from a transmitting entity to a receiving entity. The transmitting entity transmits data to the receiving entity. The transmitting entity interrupts transmission of data, and the transmitting entity resumes transmission of data in response to a request from the receiving entity. The transmitting entity either waits to receive the request from the receiving entity before resuming transmission of data or solicits the request from the receiving entity to resume transmission of data.

### BACKGROUND

This invention relates generally to a method and system for transmitting data in a communication system. More particularly, this invention relates to a method and system for resuming transmission of data in a communication system after interruption.

FIG. 1 is a block diagram of an exemplary cellular radiotelephone system, including an exemplary base station 110 and a mobile station 120. Although denoted a “mobile station”, the station 120 may also be another type of remote station, e.g., a fixed cellular station. The base station includes a control and processing unit 130 which is connected to the a mobile switching center (MSC) 140 which in turn is connected to a PSTN (not shown). General aspects of such cellular radiotelephone systems are known in the art. The base station 110 handles a plurality of voice channels through a voice channel transceiver 150, which is controlled by the control and processing unit 130. Also, each base station includes a control channel transceiver 160, which may be capable of handling more than one control channel. The control channel transceiver 160 is controlled by the control and processing unit 130. The control channel transceiver 160 broadcasts control information over the control channel of the base station or cell to mobiles locked to that control channel. It will be understood that the transceivers 150 and 160 can be implemented as a single device, like the voice and control transceiver 170, for use with control and traffic channels that share the same radio carrier.

The mobile station 120 receives the information broadcast on a control channel at its voice and control channel transceiver 170. Then, the processing unit 180 evaluates the received control channel information, which includes the characteristics of cells that are candidates for the mobile station to lock on to, and determines on which cell the mobile should lock. Advantageously, the received control channel information not only includes absolute information concerning the cell with which it is associated, but also contains relative information concerning other cells proximate to the cell with which the control channel is associated, as described for example in U.S. Pat. No. 5,353,332 to Raith et al., entitled “Method and Apparatus for Communication Control in a Radiotelephone System”.

Modem communication systems, such as cellular and satellite radio systems, employ various modes of operation (analog, digital, dual mode, etc.), and access techniques such as frequency division multiple access (FDMA), time division multiple access (TDMA), code division multiple access (CDMA), and hybrids of these techniques.

In North America, a digital cellular radiotelephone system using TDMA is called the digital advanced mobile phone system (D-AMPS), some of the characteristics of which are specified in the TIA/EIA/IS-136 standard published by the Telecommunications Industry Association and Electronic Industries Association (TIA/EIA). Another digital communication system using direct sequence CDMA is specified by the TIA/EIA/IS-95 standard. There are also frequency hopping TDMA and CDMA communication systems, one of which is specified by the EIA SP 3389 standard (PCS 1900). The PCS 1900 standard is an implementation of the GSM system, which is common outside North America, that has been introduced for personal communication services (PCS) systems.

Several proposals for the next generation of digital cellular communication systems are currently under discussion in various standards setting organizations, which include the International Telecommunications Union (ITU), the European Telecommunications Standards Institute (ETSI), and Japan's Association of Radio Industries and Businesses (ARIB). Besides transmitting voice information, the next generation systems can be expected to carry packet data and to inter-operate with packet data networks that are also usually designed and based on industry-wide data standards such as the open system interface (OSI) model or the transmission control protocol/Internet protocol (TCP/IP) stack. These standards have been developed, whether formally or de facto, for many years, and the applications that use these protocols are readily available. The main objective of standards-based networks is to achieve interconnectivity with other networks. The Internet is today's most obvious example of such a standards-based packet data network in pursuit of this goal.

Advantages of introducing a packet data protocol in cellular systems include the ability to support high data rate transmissions and at the same time achieve a flexibility and efficient utilization of the radio frequency bandwidth over the radio interface. General Packet Radio Service (GPRS), which is the packet mode for the Global System for Mobile Communication (GSM) standard, is designed for so-called “multislot operations” where a single user is allowed to occupy more than one transmission resource simultaneously.

An overview of the GPRS network architecture is illustrated in FIG. 2A. Information packets from external networks enter the GPRS network at a GGSN (Gateway GPRS Service Node) 10. A packet is then routed from the GGSN via a backbone network, 12, to a SGSN (Serving GPRS Support Node), 14, that is serving the area in which the addressed GPRS remote station resides. From the SGSN 14, the packets are routed to the correct BSS (Base Station System), in a dedicated GPRS transmission. The BSS includes a plurality of base transceiver stations (BTS), only one of which, BTS 18, is shown and a base station controller (BSC) 20. The interface between the BTSs and the BSCs are referred to as the A-bis interface. The BSC is a GSM specific denotation, and for other exemplary systems the term Radio Network Control (RNC) is used for a node having similar functionality as that of a BSC. Packets are then transmitted by the BTS 18 over the air interface to a remote station 21 using a selected information transmission rate.

A GPRS register holds all GPRS subscription data. The GPRS register may, or may not, be integrated with the HLR (Home Location Register) 22 of the GSM system. Subscriber data may be interchanged between the SGSN and the MSC/VLR 24 to ensure service interaction, such as restricted roaming. The access network interface between the BSC 20 and MSC/VLR 24 is a standard interface known as the A-interface, which is based on the Mobile Application Part of CCITT Signaling System No. 7. The MSC/VLR 24 also provides access to the land-line system via PSTN 26.

In most digital communication systems, communication channels are implemented by frequency modulating radio carrier signals, which have frequencies near 800 megahertz (MHZ), 900 MHZ, and 1900 MHZ. In TDMA systems and even to varying extents in CDMA systems, each radio channel is divided into a series of time slots, each of which contains a burst of information from a user. The time slots are grouped into successive frames that each have a predetermined duration, and successive frames may be grouped into a succession of what are usually called superframes. This kind of access technique (e.g., TDMA or CDMA) used by a communication system affects how user information is represented in the slots and frames, but current access techniques all use a slot/frame structure.

Time slots assigned to the same user, which may not be consecutive time slots on the radio carrier, may be considered a logical channel assigned to the user. During each time slot, a predetermined number of digital bits are transmitted according to the particular access technique (e.g., CDMA) used by the system. In addition to logical channels for voice or data traffic, cellular radio communication systems also provide logical channels for control messages, such as paging/access channels for call-setup messages exchanged by base stations and mobile stations. In general, the transmission bit rates of these different channels need not coincide, and the lengths of the slots in the different channels need not be uniform. The set of possible transmission bit rates for a channel is typically a limited integer value and is known to both the transmitter and the receiver which use that channel.

In cellular radio systems, an air interface protocol is required in order to allow a mobile station to communicate with the base stations and a mobile switching center (MSC). The air interface protocol is used to initiate and to receive cellular telephone calls. A physical layer (Layer 1) defines the parameters of the physical communications channel, e.g., carrier radio frequency spacing, modulation characteristics, etc. A link layer (Layer 2) defines the techniques necessary for the accurate transmission of information within the constraints of the physical channel, e.g., error correction and detection, etc. A Radio Resource Control (RRC) Layer 3 defines the procedures for reception and processing of information transmitted over the physical channels. TIA/EIA/IS-136 and TIA/EIA/IS-95 for example specify air interface protocols. The functionality of a Layer 2 protocol includes the delimiting, or framing, of Layer 3 messages, which may be sent between communicating Layer 3 peer entities residing within mobile stations and cellular switching systems.

The physical channel between the remote station and the base station is typically divided into time frames, as illustrated in FIG. 2B. The information unit transmitted during a time frame can be called a transmission block. In the next generation systems, data can be grouped into packets for transmission. One or several data packets can be transmitted within a transmission block.

At the Layer 2 level, a packet typically comprises a header part, an information part (I-part), and an error detection code part. To ensure safe receipt of a long (multi-line) message, an Automatic Re-transmission request (ARQ) mode transaction may be used. According to the ARQ scheme, the header part typically includes information used for requesting re-transmission of corrupted packets. The error detecting part, called the Cyclic Redundancy Code (CRC), is used to determine if the rest of the packet has been corrupted in some way when transmitted on the channel. If so, a re-transmission request signal is transmitted to the transmitter, and the original data is re-transmitted.

According to the ARQ scheme, only the frames that are not successfully received by the receiving entity need to be re-transmitted. However, since transmission of a long message may take a substantial amount of time, there might be a need to interrupt the ARQ Mode transaction, e.g., to transmit a more time critical message. The IS-136 standard does not provide a technique for resuming a previously interrupted ARQ Mode transaction. Thus, according to the IS-136 standard, when an ARQ Mode transaction is interrupted, it is aborted and must be started all over again, from the beginning of the message being transmitted. This wastes bandwidth. The longer the message, the higher the risk of interruption and the greater the bandwidth wasted due to interruption.

In addition, if transmission of the message is re-started on a channel normally occupied by other data, this leads to an interruption of other data. For example, if the message is transmitted on the Fast Associated Control Channel (FACCH), re-starting transmission of the message leads to an unnecessary interruption of voice, since the FACCH uses the same space normally occupied by the voice.

Thus, there is a need for a method and system for resuming transmission of data after interruption of transmission, without requiring that the transmission process be started over.

### SUMMARY

It is therefore an object of the present invention to provide a way of resuming transmission of data after interruption of transmission without requiring the transmission process to be started over from the beginning.

According to an exemplary embodiment, these and other objects are met by a method and system for transmitting data from a transmission entity to a receiving entity. The transmission entity transmits data to the receiving entity. The transmission entity interrupts transmission of data, and the transmitting entity resumes transmission of data in response to a request from the receiving entity. The transmission entity either waits to receive the request from the receiving entity before resuming transmission of data or solicits the request from the receiving entity.

### BRIEF DESCRIPTION OF THE DRAWINGS

The features, objects, and advantages of this invention will become apparent by reading this description in conjunction with the accompanying drawings, in which like reference numerals refer to like elements and in which:

FIG. 1 is a block diagram of an exemplary cellular radiotelephone communication system;

FIG. 2A illustrates a GSM/GPRS network architecture;

FIG. 2B illustrates a physical channel divided into frames;

FIGS. 3A-3C illustrate frame exemplary formats for ARQ Mode BEGIN, ARQ Mode CONTINUE and ARQ STATUS frames, respectively;

FIG. 4 illustrates how an ARQ Mode transaction may be interrupted and resumed, according to an exemplary embodiment of the present invention.

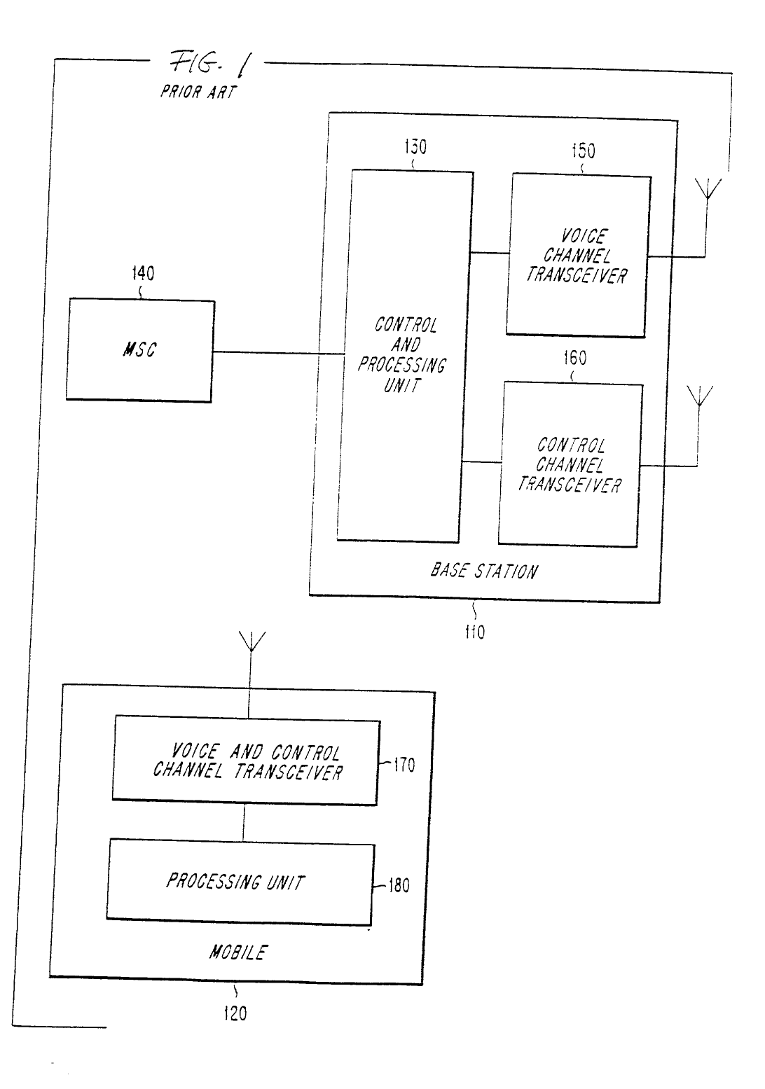

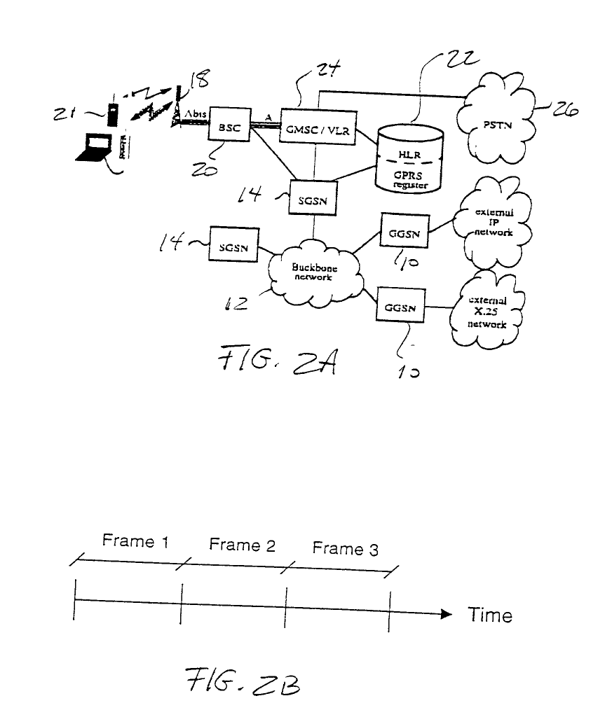

### DETAILED DESCRIPTION

For illustrative purposes, the following description is directed to a cellular radio communication system, but it will be understood that this invention is not so limited and applies to other types of communication systems.

According to exemplary embodiments of the invention, transmission of data from a transmitting entity to a receiving entity can be resumed after interruption of the transmission, without requiring that the transmission process be started over from the beginning. For illustrative purposes, the following description is directed ARQ mode transactions in a system complying with portions of the IS-136.2 standard, rev. A. However, the invention is not limited to such an application but may be applied to other types of transactions and/or other air-interface standards.

According to an exemplary embodiment, existing definitions in the IS-136 standard for uninterrupted ARQ Mode transactions in a receiving entity can be used to permit the transmitting entity to resume transmission of a message when it is interrupted, rather than requiring the transmitting entity to start the transmission of the message from the beginning. According to an exemplary embodiment, a transmitting entity transmits a first frame of an ARQ Mode transaction, e.g., an ARQ Mode BEGIN frame, to a receiving entity, to begin an ARQ Mode transaction. From information in the ARQ Mode BEGIN frame, the receiving entity calculates the total number of frames expected, e.g., the number of frames including the ARQ Mode BEGIN frame and any ARQ Mode CONTINUE frames. The receiving entity determines whether the frames are received within a time specified, e.g., according to the IS-136.2, rev. A standard. If the time allowed between two succeeding received frames expires, a frame indicating the current status of the receiving entity, e.g., an ARQ STATUS frame, is sent from the receiving entity to the transmitting entity. This is explained, for example, in sections 2.6.5.8-9 of the IS-136.2, rev. A standard.

The ARQ Mode transaction may be interrupted, e.g, due to the need to transmit a more time critical message, such as an Acknowledgment message in response to a message requiring such an acknowledgment, e.g., a Status Message. Examples of such messages are given in IS-136.2, rev. A, sections 2.7.3.1.3.2.9 and 2.6.5.6.2. The ARQ Mode transaction may also be interrupted for handoff or to transmit channel quality measurements (CQM). According to an exemplary embodiment, after completion of the interruption of an ARQ Mode transaction, the receiving entity sends an ARQ STATUS frame to the transmitting entity to indicate to the transmitting entity that the receiving entity is still in a mode of operation to receive the rest of the ARQ frames.

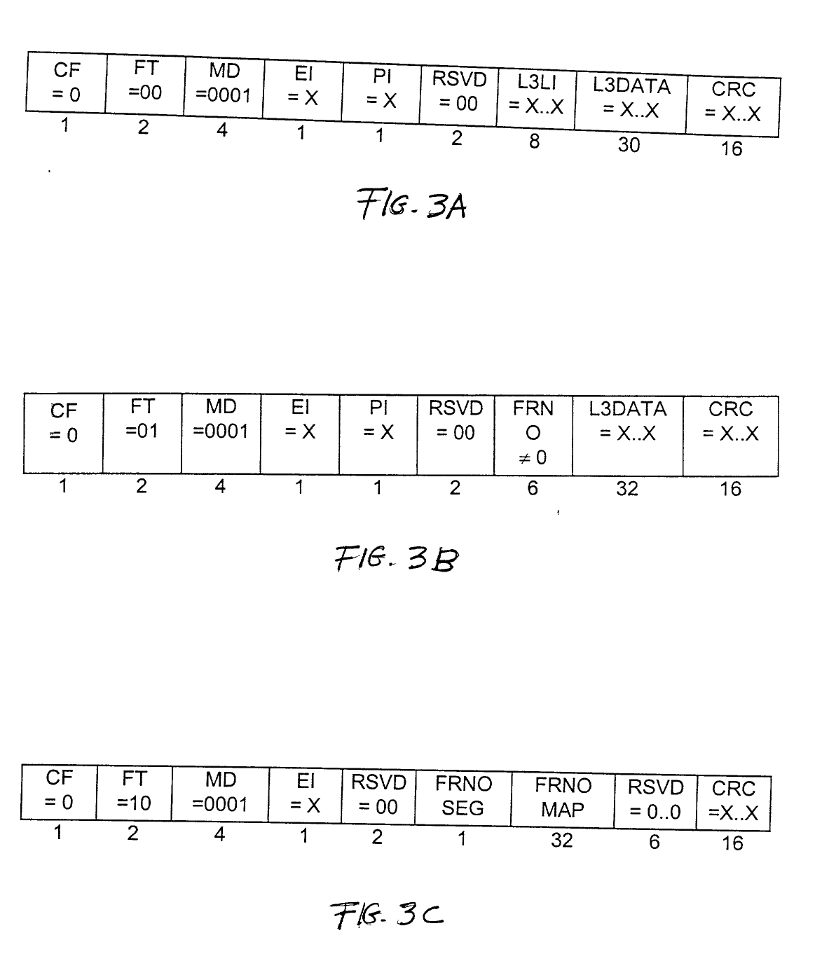

According to the IS-136 standard, ARQ Mode message transmissions may be supported on a Digital Traffic Channel (DTC) using FACCH channel encoding along with the protocol formats shown in FIGS. 3A-3C. The fields comprising each protocol frame are presented to the FACCH convolutional coder starting with the leftmost field. The most significant bit (leftmost) within a field is presented to the coder first. It will be appreciated that the ARQ Mode message transmissions may also be supported using other types of channel encoding, e.g., Slow Associated Control Channel (SACCH) encoding. Examples of such coding are described in detail in sections 2.7.3.1.1 and 2.7.3.1.2 of the IS-136.2, rev. A standard.

FIGS. 3A-3C depict ARQ Mode frame formats according to the IS-136.2, rev. A standard. FIG. 3A depicts an ARQ Mode BEGIN frame, FIG. 3B depicts an ARQ Mode CONTINUE frame, and FIG. 3C depicts an ARQ STATUS frame. The ARQ Mode BEGIN and ARQ Mode CONTINUE frames are sent by the transmitting entity. The ARQ STATUS frame is sent by the receiving entity. These formats are described, for example, in IS-136.2, rev. A, section 2.7.3.2.1 for the FACCH. Similar formats are described in section 2.7.3.2.2 for the SACCH.

Referring to FIG. 3A, the ARQ Mode BEGIN frame includes a Continuation Flag (CF) field, a Frame Type (FT), and a Mode Discriminator (MD) field. In non-ARQ mode frames, the CF indicates whether the message is a continuation of a message from a previous frame. For example, if the CF is set to one, this indicates that the frame contains a subsequent word of a multiple-word message and that interruption is not permitted. In the ARQ Mode frames, the CF is set to zero, thus permitting the ARQ mode transmission to be interrupted. The FT field identifies the type of ARQ frame. For example, if FT is 00, this identifies an ARQ Mode BEGIN frame, if FT is 01, this identifies an ARQ Mode CONTINUE frame, if FT is 10, this identifies an ARQ STATUS frame, and if FT is 11, this indicates that the frame is Reserved, e.g, for another purpose. The MD field is used to discriminate between unacknowledged mode and ARQ Mode. For example, if the MD field contains the value 0001, this indicates that the mode is the ARQ Mode.

The ARQ Mode BEGIN frame also includes an Encrypting Indicator (EI) field, a Polling Indicator (PI) field, and a Reserved (RSVD) field. The EI field indicates whether or not an ARQ Mode frame is encrypted. For example, if the EI is one, encryption is enabled, whereas if EI is zero, encryption is not enabled. The PI field indicates whether or not the transmitting entity is soliciting a response, e.g., an ARQ STATUS frame, from the receiving entity. For example, if PI is zero, an ARQ STATUS frame is not being solicited. If PI is one, this indicates that the ARQ STATUS frame is being solicited. The RSVD field includes bits reserved for another purpose, e.g., a future use. The bits in this field may be set to zero and ignored by the receiving entity.

The ARQ Mode BEGIN frame also includes a Layer 3 Data (L3Data) field and a Layer 3 Length Indicator (L3LI) field, as well as a CRC. The CRC field includes a CRC code that is used to calculate a check over all of the preceding bits, as well as the DVCC. This is described, for example, in IS-136.2, rev. A, section 2.7.3.1.1.3. The L3DATA field contains a portion or all of the L3 message having an overall length indicated by the L3LI field. If the L3 message is too long to fit within a single ARQ Mode BEGIN frame, then the remaining data can be carried using additional ARQ Mode CONTINUE frames as necessary, with some predetermined limit of ARQ Mode continue frames, e.g., 63. If the L3DATA is not filled up by the L3 message, the portion of the field not used can be filled with zeros. A typical format for an ARQ Mode CONTINUE frame is depicted in FIG. 3B.

As shown in FIG. 3B, the ARQ Mode CONTINUE frame includes the same information as the ARQ Mode BEGIN frame except that instead of including an L3LI, the ARQ Mode CONTINUE frame includes a Frame Number (FRNO) field that uniquely identifies each ARQ Mode CONTINUE frame sent in delivering a complete L3 message. The FRNO field is incremented for each new ARQ Mode CONTINUE frame sent. When an ARQ Mode CONTINUE frame is resent because of incorrect frame reception at the receiving entity, the FRNO field remains unchanged from the value used when the frame was initially sent.

Referring to FIG. 3C, the ARQ STATUS frame includes the same fields as the ARQ Mode CONTINUE frame except that instead of an FRNO field and a L3DATA field, the ARQ STATUS frame includes a Frame Number Segment (FRNO SEG) field and a Frame Number Map (FRNO MAP) field. The FRNO SEG field is used to identify which segment of the Frame Number Map is being provided. For example, if the FRNO SEG is 0, this indicates that segment 0 (including frames 0 through 31) is being provided, or if the FRNO SEG is 1, this indicates that segment 1 (including frames 32 through 63) is being provided. The FRNO MAP is a partial or complete bit representation indicating which ARQ frames have been successfully received by the receiving entity. For example, if a bit in the FRNO MAP equals 1, this indicates that the frame has been successfully received. If a bit in the FRNO MAP equals 0, this indicates that the frame has not been received. The FRNO MAP may contain, for example, 32 bits, one representing each frame.

According to an exemplary embodiment, the PI, sent by the transmitting entity, and the ARQ STATUS frame, sent by the receiving entity, can be used to determine if the receiving entity and the transmission entity, respectively, are still in the correct mode of operation to handle a specific ARQ Mode transmission.

After interruption of an ARQ Mode transaction, the transmitting entity may wait a certain amount of time, e.g., 12 seconds, for the receiving entity to send an unsolicited ARQ STATUS frame. This may happen, e.g., if the receiving entity is still in a state to receive the rest of the transaction, and an ARQ Mode CONTINUE Timeout is caused by the transmitting entity not transmitting the next frame within the expected time window. This is described, for example, in IS-136.2 rev. A, section 2.6.5.9.2.

Instead of waiting for the unsolicited ARQ STATUS frame, the transmitting entity can solicit, i.e., request, the ARQ STATUS frame from the receiving entity. This may be achieved by transmitting the next ARQ Mode CONTINUE frame with the PI equal to one. If the receiving entity is still in the ARQ CONTINUE mode, it will acknowledge the PI with an ARQ STATUS frame.

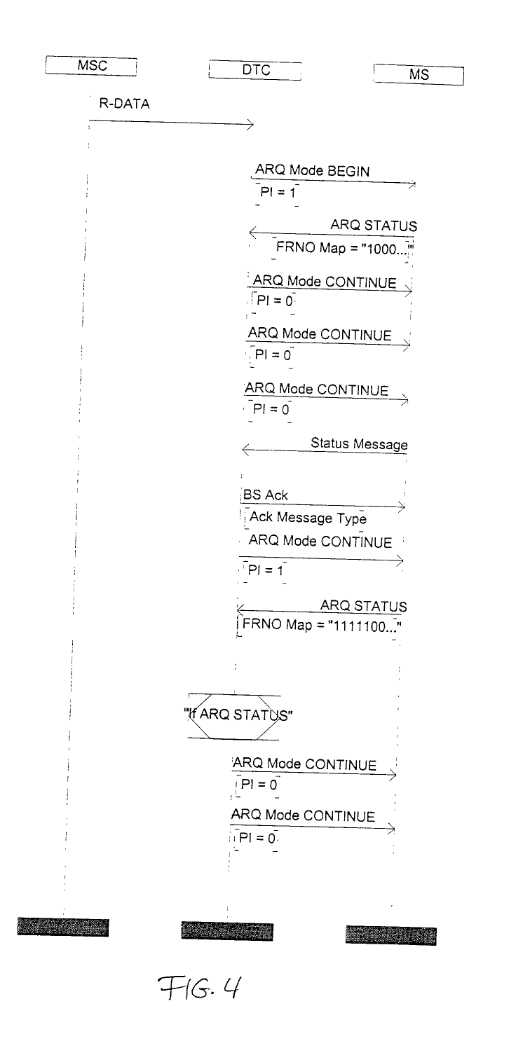

Either of these techniques results in the receiving entity transmitting an ARQ STATUS frame to the transmitting entity, if the receiving entity is still in the ARQ CONTINUE mode. The second technique, which is more efficient, is depicted in FIG. 4.

FIG. 4 illustrates how an ARQ Mode transaction, terminated in a receiving entity, can be interrupted by a Status Message. In FIG. 4, the transmitting entity is depicted as a base station (BS), and the receiving entity is depicted as a mobile station (MS). It should appreciated that the transmitting entity and the receiving entity may be other devices. For example, the transmitting entity may be a BSC, an MSC, or an MS, and the receiving entity may be a BS, a BSC, or an MSC. As shown in FIG. 4, an MSC transmits an R-DATA message to the BS over a DTC to a particular MS. In the example shown in FIG. 4, the R-DATA is sent while the BS and the MS are already in a conversation state. The R-DATA may be sent at any time, after initial connection.

The BS begins an ARQ Mode transaction by transmitting an ARQ Mode BEGIN frame to the MS. The PI is set to 1, indicating a request for the MS to send an ARQ STATUS frame. The MS responds with an ARQ STATUS frame with the FRNO MAP set to 1000 . . . indicating that the MS has received the first frame successfully. An ARQ Mode CONTINUE frame is sent to the MS. The PI is then set to 0, and ARQ Mode CONTINUE frames are repeatedly sent to the MS. After a few more ARQ Mode CONTINUE frames are sent, the MS sends a Status Message. The BS responds with a BS Acknowledgement (Ack) message, interrupting the ARQ Mode transaction. The ARQ transaction is resumed by the BS transmitting the next ARQ Mode CONTINUE frame, with the PI equal to one. If the MS responds to the PI by transmitting an ARQ STATUS frame, the BS will know that the MS is in a mode to handle the rest of the transaction. Otherwise, if no ARQ STATUS message is received by the BS, the BS may repeat the ARQ Mode CONTINUE frame. Eventually, if no ARQ STATUS message is received by the BS, the ARQ Mode transaction is aborted.

If the BS receives the ARQ STATUS frame, with the FRNO map set to, for example, 1111100 . . . indicating that the first five frames have been successfully received by the MS, the process continues as long as the both the MS and the BS are in the ARQ Mode. Of course, the FRNO map may be set to 1---100 . . . where “-” may be a 1 or a 0, since any of the frames between the ARQ BEGIN frame and the last frame with PI=1 may or may not have been received.

Although not illustrated, it will be appreciated that the ARQ Mode transaction may be interrupted by other messages from the MS, e.g., a CQM reports, or the interruption can be initiated by the MSC or BS, e.g., to perform handoff of the MS.

According to exemplary embodiments, a technique is provided for resuming retransmission after interruption, without requiring that the re-transmission process be started over. This results in a savings of bandwidth. Also, existing messages provided for in the receiving and transmitting entities may be used.

It will be appreciated by those of ordinary skill in the art that this invention can be embodied in other specific forms without departing from its essential character. The embodiments described above should therefore be considered in all respects to be illustrative and not restrictive. For example, although the embodiments described above are directed to an IS-136 environment, the invention is not limited to a system complying with this standard.

What is claimed is:

1. A method for transmitting data, comprising:
transmitting data from a transmitting entity to a receiving entity;
interrupting transmission of data by the transmitting entity; and
resuming transmission of data by the transmitting entity in response to a request from the receiving entity.

2. The method of claim 1, wherein the transmitting entity waits to receive the request from the receiving entity before resuming transmission of data.

3. The method of claim 1, wherein the transmitting entity solicits the request from the receiving entity to resume transmission of data.

4. The method of claim 1, wherein the transmitting entity is a base station, a base station controller, or a mobile switching center, and the receiving entity is remote station.

5. The method of claim 1, wherein the transmitting entity is a remote station, and the receiving entity is a base station, a base station controller, or a mobile switching center.

6. The method of claim 1, wherein the data includes one or more messages, each transmitted over one or more frames.

7. The method of claim 1, wherein the data is formatted as automatic retransmission request (ARQ) data.

8. The method of claim 1, wherein interrupting transmission of data by the transmitting entity is performed in response to a request from the receiving entity.

9 The method of claim 1, wherein interrupting transmission of data by the transmitting entity is initiated by the transmitting entity.

10. A system for transmitting data, comprising:
a transmitting entity; and
a receiving entity, wherein the transmitting entity transmits data to the receiving entity, the transmitting entity interrupts transmission of data in response to a request from the receiving entity, and the transmitting entity resumes transmission of data in response to a request from the receiving entity.

11. The system of claim 10, wherein the transmitting entity waits to receive the request from the receiving entity before resuming transmission of data.

12. The system of claim 10, wherein the transmitting entity solicits the request from the receiving entity to resume transmission of data.

13. The system of claim 10, wherein the transmitting entity is a base station, a base station controller, or a mobile switching center, and the receiving entity is mobile station.

14. The system of claim 10, wherein the transmitting entity is a mobile station, and the receiving entity is a base station, a base station controller, or a mobile switching center.

15. The system of claim 10, wherein the data includes one or more messages transmitted over one or more frames.

16. The system of claim 10, wherein the data is formatted as automatic re-transmission request (ARQ) data.

17 The system of claim 10, wherein the transmitting entity interrupts transmission of data in response to a request from the receiving entity.

18 The system of claim 10, wherein the transmitting entity initiates interruption of transmission of data.
